(19) United States
(12) Patent Application Publication
(10) Pub. No.: US 2004/0123106 A1
(43) Pub. Date: Jun. 24, 2004

(54) APPARATUS AND METHODS FOR MOTION AND PROXIMITY ENHANCED REMOTE IDENTITY BROADCAST WITH BIOMETRIC AUTHENTICATION

(75) Inventors: Michael R. D'Angelo, Melrose, MA (US); Bruce W. Moulton, Marblehead, MA (US); Thomas R. Armstrong, Weston, MA (US); Bardwell C. Salmon, Groton, MA (US)

Correspondence Address: Michael R. D'Angelo, 9 Merian Street, Suite 28, Lexington, MA, 02420, US

(73) Assignee: LEXENT TECHNOLOGIES, INC., Lexington, MA (US)

(21) Appl. No.: 10/604,915

(22) Filed: Aug. 26, 2003

Related U.S. Application Data
(60) Provisional application No. 60/406,111, filed on Aug. 27, 2002.

(51) Int. Cl. H04L 9/00

(52) U.S. Cl. 713/171; 713/201

(57) ABSTRACT

Apparatus and methods for motion and proximity enhanced remote identity broadcast with biometric authentication are described. An apparatus according to the invention includes an authentication element that receives a biometric characteristic from a user. The authentication element broadcasts an authorization signal in response to identifying the user. The apparatus further includes a device communicator in wireless communication with the authentication element and in electrical communication with a computing device. The device communicator permits the user to access the computing device in response to receiving the authorization signal broadcasted by the authentication element. In one embodiment, the apparatus also includes a sensor that is attached to the authentication element or the device communicator. The sensor generates a sensor signal that is related to a status of at least one of the authentication element, the device communicator, and the computing device.

### CROSS REFERENCE TO RELATED APPLICATIONS

This patent application claims priority to U.S. provisional patent application Serial No. 60/406,111, filed on Aug. 27, 2002, the entire disclosure of which is incorporated herein by reference.

### BACKGROUND OF INVENTION

The two key elements of good authentication, strength and convenience, have historically been in direct conflict with each other. Strong has meant inconvenient, while convenient has meant weak. Current products on the market allow for one or the other, not both. This “authentication dilemma” has created an unfulfilled market need.

Information security professionals universally agree that a stronger means of authentication would be of great value if it were “deployable”, or otherwise stated, if it was customizable, strong, convenient, possessed low overhead and was cost effective.

There are many factors that have historically prevented a good authentication system from gaining strength in the marketplace: tethers, readers, associated infrastructure & process costs and cumbersome usage aspects. Long complex passwords are easily forgotten and administrative functions, such as password resets, are costly.

### BRIEF DESCRIPTION OF DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates the connectivity between the Interface & Administration Software (IASW), the Computing Device (CD), the Authentication Element (AE) and the Device Communicator (DC), in accordance with one embodiment of the invention.

FIG. 2 illustrates the connectivity between components for a two component system comprised of the Authentication Element (AE ) and the Device Communicator (DC), in the absence of the Interface & Administration Software (IASW), in accordance with another embodiment of the invention.

FIG. 3 illustrates the connectivity between components for a two component system comprised of the Authentication Element (AE) and the Interface & Administration Software (IASW), in the absence of the Device Communicator (DC), in accordance with another embodiment of the invention.

FIG. 4 illustrates the main component of the system, the Authentication Element (AE), in accordance with one embodiment of the invention.

FIG. 5 illustrates the Device Communicator (DC) used to provide an optional wireless interface and motion sensing means to a Computing Device (CD), in accordance with one embodiment of the invention.

### DETAILED DESCRIPTION

The current invention addresses the two gating elements in the authentication space: strength and convenience. It is made up of a small bio-authenticated, wireless token with a user customizable feature set to suit individual needs, allowing for a secure, wireless personal data store that is biometrically activated. It is capable of wirelessly broadcasting information once biometrically activated, and may optionally invoke a rules-based security protocol keyed to motion and proximity.

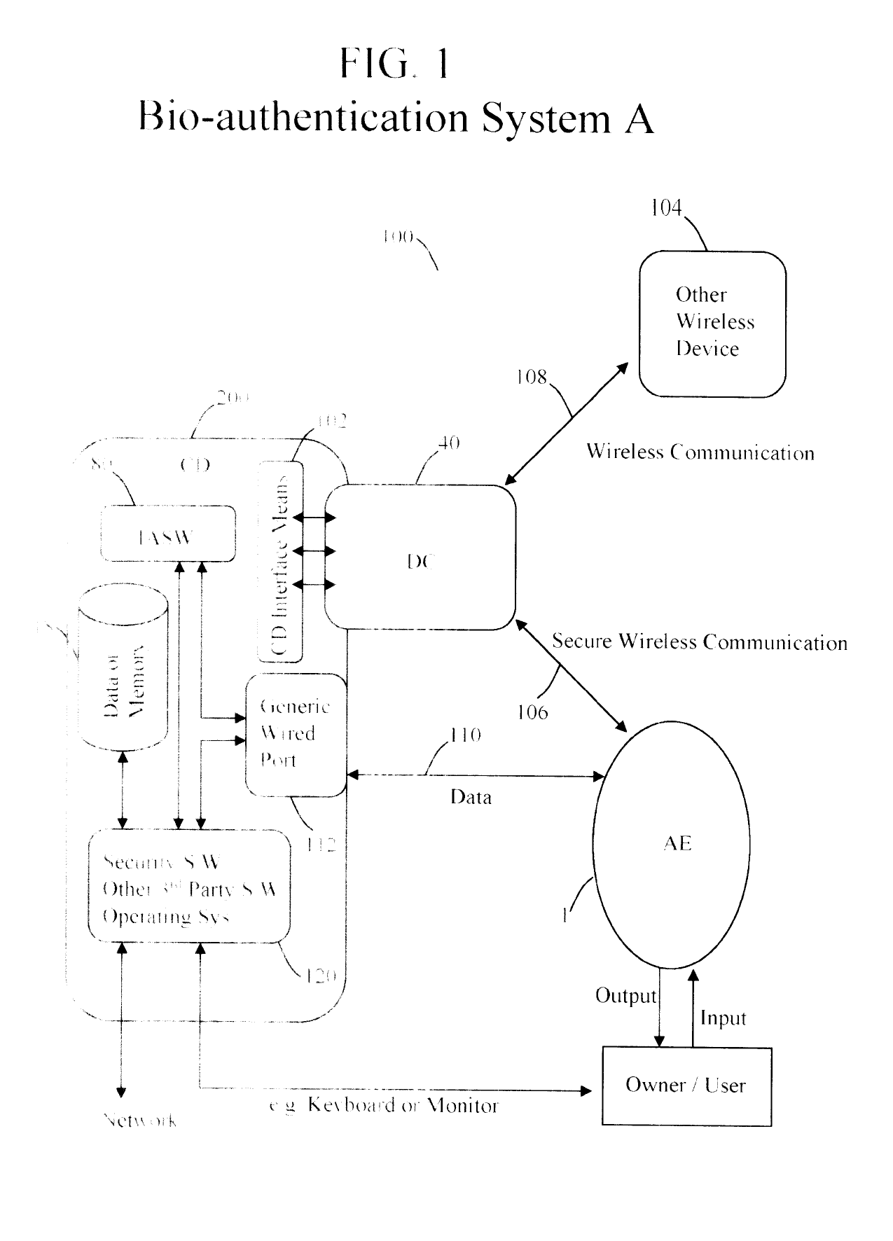

FIG. 1 depicts one embodiment of the invention, the Bio-authentication System A 100, that may consist of three components: an authentication element (“AE”) 1, a device communicator (“DC”) 40, and interface/administration software (“IASW”) 80.

The AE 1 and DC 40 may each contain means for securely (stored, processed and/or transmitted in a way that resists unauthorized access, use or observation and maintains integrity) communicating with the other, with the preferred communication means being wireless including but not limited to radio frequency, audio, infrared or microwave. The DC 40 and the IASW 80 may also securely communicate with each other using means provided by the computing device (“CD”) 200 to which the DC 40 may be attached and that may host/execute the IASW 80.

Using methods and means described in this section, and depicted graphically in FIG. 1, the Bio-authentication System A 100 contains an AE 1 that may be bound to (trusts and is trusted by) one or more DCs 40, and the AE 1 may be bound to its registered owner/user (a natural person). The AE 1 may also be bound to other natural persons who are assigned roles other than owner.

When strongly authorized by a trusted owner/user to do so (based on two-factor authentication, defined as something the person has, the AE 1, and something the person is, the biometric signature), the AE 1 electronically may represent (“speak for” or “is a proxy for”) that trusted owner/user by securely and wirelessly broadcasting the owner/user's identity credentials and/or other data to a trusted DC 40 and/or by allowing the owner/user's motion status and proximity to a trusted DC 40 to be determined. The AE 1 may also interface with its owner/user in order to receive inputs (such as bio-authenticated authorization to wirelessly broadcast data) and to provide outputs (such as alarms, alerts, distress beacons, etc.). The DC 1 may be bound to (trusts and is trusted by) IASW 80 objects with which it may communicate securely. The DC 40 may also be bound to one or more AEs 1 with which the DC 40 may communicate securely and wirelessly.

Using methods and means described in detail below, the DC 40 may serve as a proxy for a CD 200 to which it may be electronically interfaced and physically attached though the CD interface means 102. The DC 40 may be capable of determining the motion status of the CD 200 and may relay data (such as requests for login credentials or administrative instructions/data concerning the AE 1) from the CD 200 to any AE 1 that the DC 40 trusts. The CD interface means 102 may be in the form of any standard electronic interface such as USB, Firewire or PCMCIA. The DC 40 may also serve as a proxy for any AE 1 that it trusts by being able to relay data (such as login credentials or other data/instructions) from such an AE 1 to the CD 40. The DC 40 may use data from its own motion sensor 60, wireless data 30 received from a trusted AE 1 about the AE's 1 motion/proximity status and predefined rules stored in its DC microprocessor 44 and DC secure memory 46 to reach conclusions about the CD's 200 probable threat environment and to propagate appropriate alerts/notices to the CD 200, to a trusted AE 1, to itself and/or to other compatible devices/systems within the DC's 40 communication range. The DC 40 may optionally exist with a separate physical attachment 114 that securely fastens it to the CD 200. Examples of such optional physical attachments 114 may include adhesives, double sided tape or a key-lock mechanism.

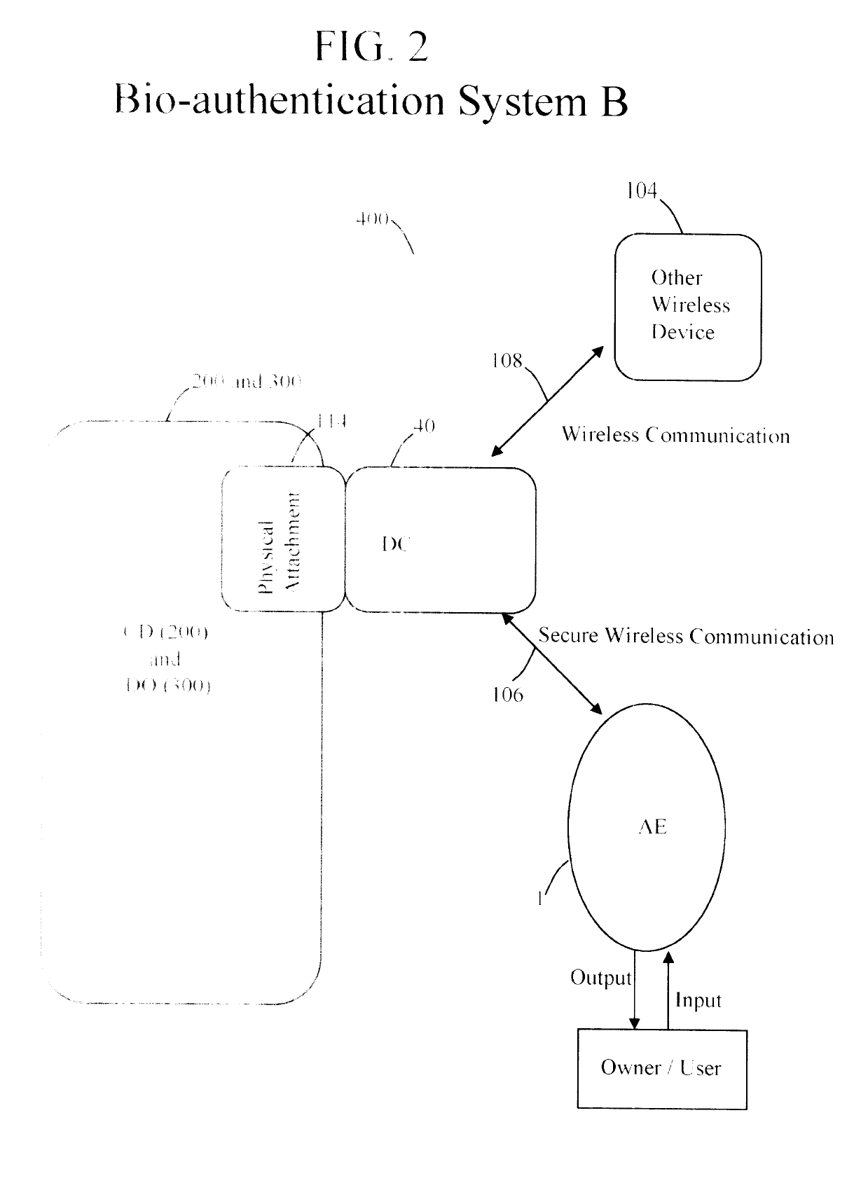

In a second embodiment, depicted in FIG. 2, the invention may consist of two components only, the AE 1 and the DC 40, and may not contain the IASW 80. In this Bio-authentication System B 400, the CD 200 may not necessarily be a CD 200 but may also be a generic device/object (“DO”) 300 secured with a bio-authenticated motion/proximity sensitive means that may be capable of using audible means as a theft deterrent. Examples of such DO's 300 include briefcases and other high value mobile items. In such a case there may be no electronic CD interface means 102 from the DC 40 to the CD 200 or DO 300, and the DC 40 may therefore optionally exist with a physical attachment 114.

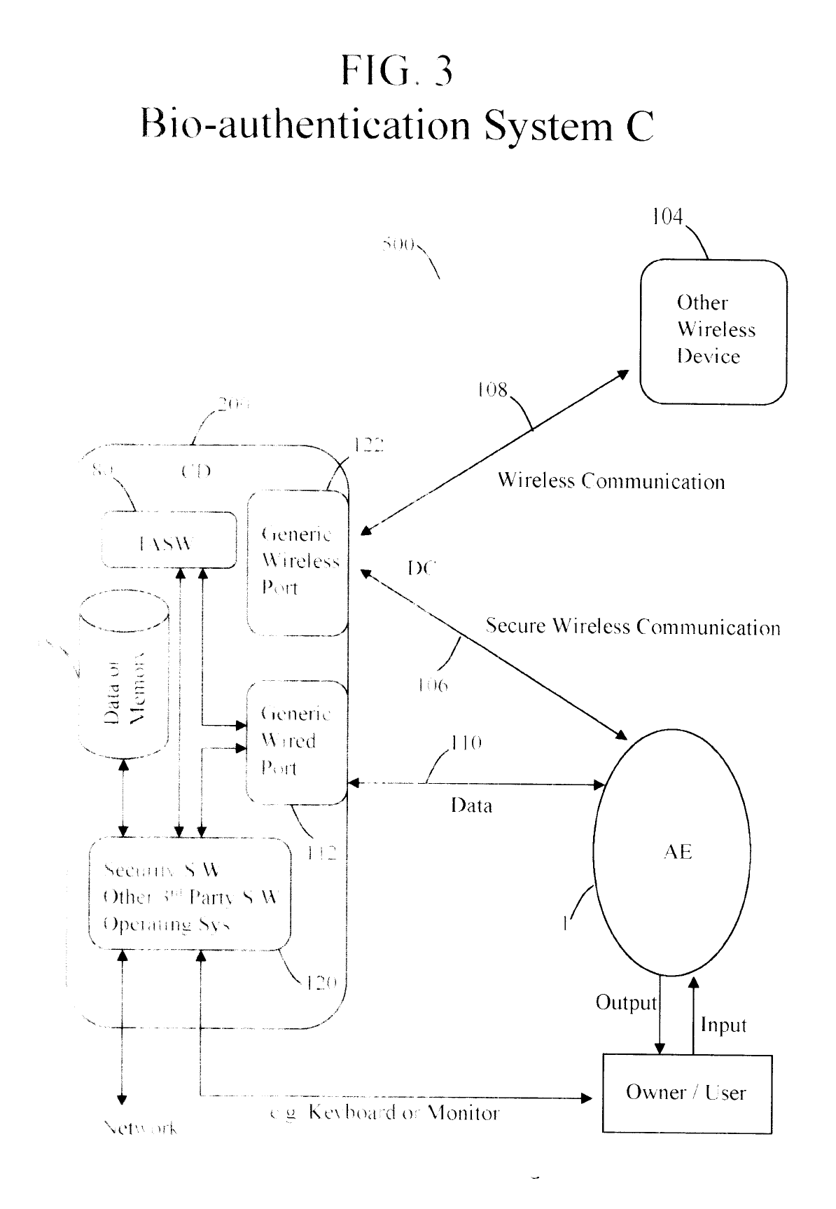

In a third embodiment, depicted in FIG. 3, the invention may consist of two components only, this time the AE 1 and IASW 80 only, and may not contain the DC 40. In this Bioauthentication System C 500, the DC 40 may not be required because the CD 200 may contain a built-in means for wireless communication enabling it to communicate direct with the AE 1. Examples of such built-in wireless capabilities exist today in the form of Bluetooth, 802.11 a, 802.11 b, among others. In such a case there may be no need for the DC 40 to provide the wireless interface means and the remainder of the functionality may be captured within the IASW 80 and AE 1.

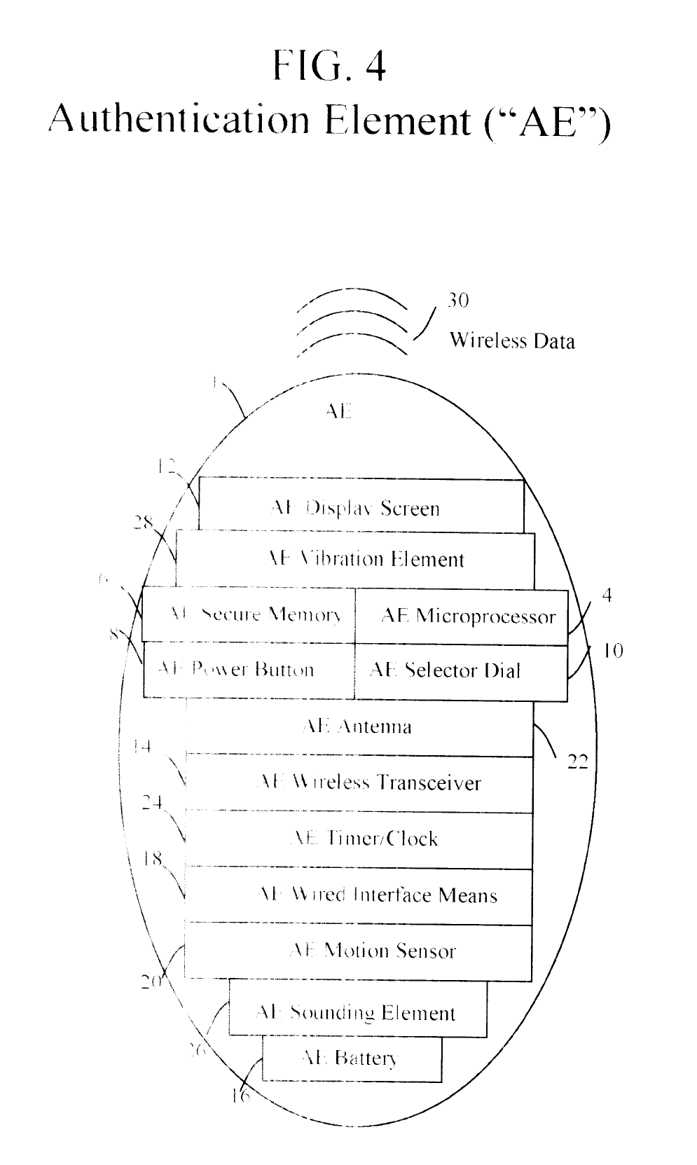

In its most highly functional form shown in FIG. 4, the AE 1 may be one component of a combined motion & proximity system for asset and data protection and one component of a bio-authentication system. The AE 1 is a secure, private repository of user identifier, authenticator and/or other information. The AE 1 may be activated by its owner via biometric authentication (“bio-authentication”). The AE 1 may provide secure wireless notification/broadcast of its own trustworthy credentials, the user's credentials and/or other information to a DC 40 or other system that the AE 1 and/or user trusts, while simultaneously communicating with the DC 40 regarding motion & proximity status. All broadcasts of sensitive information by the AE 1 and all administrative and/or configuration actions that impact the AE 1 may be either directly authorized by the owner of the AE 1 via bio-authentication or may have been predefined in a rules database by the owner via a bio-authenticated process. Given the above capabilities, the AE 1 may function as a proxy for its registered owner/user.

The input to the AE 1 is through the AE biometric sensor 2, the AE antenna 22, the AE power button 8, the AE selector dial 10 and the AE wired interface connector 18. To turn the AE 1 on, the user may activate the AE power button 8. Once activated, the AE microprocessor 4 may initiate communication with the user through one or more means that may include the AE display screen 12, the AE sounding element 26 or the AE vibration element 28.

The first communication to the user may request that the user biometrically authenticate himself to the AE 1 through the AE biometric sensor 2. The input from the AE biometric sensor 2 may then be processed by the AE microprocessor 4 and compared to data that has been previously stored in the AE secure memory 6 to determine if the input from the AE biometric sensor 2 matches data from a known individual that has been previously registered (“bound”) to the AE 1.

If the input from the AE biometric sensor 2 fails to match data from a bound user that are stored in AE secure memory 6, then the AE microprocessor 4 may communicate a warning to the user that may employ the AE display screen 12, the AE sounding element 26 or the AE vibration element 28, and the AE microprocessor 4 may also optionally cause the AE 1 to power down and shut itself off.

If the input from the AE biometric sensor 2 matches data from a bound user stored in the AE secure memory 6, then the AE microprocessor 4 may communicate a successful match to the user through one or more means that may include the AE display screen 12, the AE sounding element 26 or the AE vibration element 28.

The user/owner may configure the AE 1 to broadcast periodically, upon request, in accordance to the proximity of the AE 1 to the DC, or in accordance to some other logic incorporating, but not limited to, one or more of the following: time, proximity, motion, activation command, biometric authentication match, or upon receipt of a request from the DC 40, CD 200 or IASW 80. In such a case, the AE microprocessor 4 may activate the AE wireless transceiver 14 and command it to transmit wireless data 30 containing certain information from secure memory 6 through the AE antenna 22 into free space in a clear text or encrypted format. The wireless data 30 may then be received any device configured to receive such wireless data 30 broadcast into free space. In one embodiment, the wireless data 30 may be received by the DC 40, CD 200 or DO 300.

Once the AE 1 has been powered up and the AE microprocessor 4 has established a successful match of the AE biometric sensor 2 input to a bound user stored in the AE secure memory 6, the AE microprocessor may activate the AE wireless transceiver 14 and command it to begin listening for incoming wireless communications from free space through the AE antenna 22. If incoming communications are found to exist, the AE transceiver 14 may record the communication and pass it on to the AE microprocessor 4 for processing. If the AE wireless transceiver 14 and the AE microprocessor 4 determine that the incoming communication contains data that identifies it as being intended for the AE 1, then the AE microprocessor 4 will taken action according to the content of the communication. The communication may cause the AE microprocessor 4 to initiate communication with the user through one or more means that may include the AE display screen 12, the AE sounding element 26 or the AE vibration element 28. The communication may be a warning, alert, status check, or some other message that may be of importance to the user, the DC 40, the CD 200 or the DO 300. The communication may also request that the user again biometrically authenticate himself to the AE 1 through the AE biometric sensor 2.

The AE 1 may possess certain capabilities for interfacing directly with natural persons. These capabilities may include, but are not necessarily limited to, switches, buttons, sound producing mechanisms, vibration mechanisms, indicator lights or display screens. These interface capabilities serve input or output functions, or both. In the embodiment depicted in FIG. 4, the AE power button 8 may be a push button switch, a two-position toggle switch, a press-and-hold switch, or some other simple design well known to those in the field of electronic and mechanical design. The AE display screen 12 may be a liquid crystal display (LCD) or other similar graphical display means well know to those in the field. The AE sounding element 26 may be a piezo-electric device, small speaker or other small sounding mechanism commonly known to those in the field. The AE vibration element 28 may be a piezo-electric device, an electric motor with an offset mass or other small device capable of causing a vibration that may be felt by the user, all of which are commonly known to those in the field. The AE selector dial 10 may be a dial that allow the user to toggle between alphanumeric options displayed on the AE display screen 12, the ultimate selection of which is made by depressing the dial instead of turning it, a technique commonly known to those well versed in the fields of electronic and mechanical design. The AE biometric sensor 2 may be a fingerprint or thumbprint scanning sensor, a voice recognition sensor or some other biometric sensor commonly known to those in the field of biometrics.

Each individual AE 1 may be “bound” or “paired” with at least one DC 40, CD 200 and/or DO 300, and potentially multiple DCs 40, CDs 200 and/or Dos 300 in more complex implementations where different DCs 40, CDs 200 and/or Dos 300 may be assigned different roles with respect to a given AE 1. Binding or pairing of an AE 1 to a DC 40, CD 200 or DO 300 may be a one-time administrative event that establishes a persistent state of trust between the various mixes of DCs 40, CDs 200 and/or DOs 300.

Each individual AE 1 may be bound or paired with one and only one natural person who fills the role of “owner” to that AE 1. Each individual AE 1 may be bound or paired with one or more natural persons who are assigned other trusted roles such as administrator, delegate or some other role. Binding or pairing of an AE 1 to a natural person may be a one time administrative event that establishes a persistent state of trust between the AE 1 and person pair.

The AE 1 may be implemented in various form factors. In one set of embodiments, the AE 1 may be small, light weight, battery-powered (replaceable or rechargeable), durable, water-resistant and may be wearable (e.g. via a necklace, lanyard, holster, keychain or clip) and/or pocketable. In another set of embodiments, the AE 1 may be integrated (perhaps in the form of a micro-chip or other electronic circuitry) into the circuit boards of electronic devices such as, but not limited to, computers, cell phones, PDAs or pagers. In each of the above embodiments, the AE 1 may possess other characteristics contributing to the reliability of the AE 1 under a broad set of environmental conditions. The AE 1 may be comprised of multiple pieces that are physically separable. The purpose of such physically separable pieces is to easily and perhaps temporarily add or remove functionality to/from the AE 1 in the form of accessories. One such accessory, among many other possibilities, might be a smartcard reader.

In keeping with its role as a secure data repository, the AE 1 is capable of storing data in encrypted form and/or capable of applying rules that control data access. When data does not need to be encrypted in the AE's 1 database, it may be stored “in the clear”. In keeping with the need to broadcast data securely, the AE 1 has the capability to encrypt data before broadcast and to decrypt data that is broadcast to it. This is done through the AE microprocessor 4.

Depending on the specific embodiment and depending upon certain owner/user configuration choices, the AE 1 may contain (and therefore be able to broadcast) varying amounts and types of data/credentials/information. In a highly functional and feature-rich embodiment (as could be supported by embodiments one or three), the AE 1 could contain/broadcast multiple sets of owner/user credentials (id-password pairs, public-private keys, biometric data other than that used by the AE 1, etc.) to support a range of log-in or authentication purposes. Such an AE 1 could also contain/broadcast a database of other information related to the owner/user (such as credit card numbers, demographic data, etc.). In a less functional and feature-reduced embodiment (as might be supported by embodiment two), the AE 1 might contain/broadcast only its device identifier after successful bio-authentication. Or such an AE 1 might forward/broadcast data representing the bio-authenticator (e.g. fingerprint minutia) along with its device identifier. Other combinations of data stored on and broadcast by an AE 1 are possible based on the physical/logical characteristics of a given AE 1 and based on owner/user configuration choices.

The AE 1 may be tamper-evident and tamper-resistant where these features may be implemented through physical attributes of the AE 1, through logical attributes of the AE 1 or a combination of the two. One example of a physical tamper-resistant feature would be the “potting” (e.g. casting, encasement in epoxy or another material) of the AE's 1 internal electrical components in order to increase the difficulty of gaining physical access to those internal electrical components and connections. One example of a logical tamper-evident feature would be the hashing (using MD-5, SHA-1 or some other similar algorithm) and digital signing (using one of a variety of readily available public/private key encryption tools/methods) of the AE's 1 known-good executable code so that the integrity of that code can be easily verified at a future time before deciding to rely on the AE's 1 code for some critical operation.

In order to support faster communication and to reduce the real or perceived risks of wireless communication of the AE with a DC 40, CD 200, DO 300 and/or IASW 80 objects (for example during certain sensitive administrative processes), certain embodiments of the AE 1 may be provided with a “wired” interface connector 18 such as USB, FireWire, serial, Dallas Semiconductor button, docking station or other similar means, as depicted in FIG. 4.

Information may be stored in or deleted from the AE 1, rules may be established in the AE 1 and/or configuration parameters may be set or changed in the AE 1 either by the user/owner based on bio-authentication or by a group administrator(s) to whom the AE's 1 user/owner delegates specific rights also based on bio-authentication. The user/owner and/or an authorized administrator may accomplish administrative functions such as the above either by using the interface capabilities built into the AE 1, by using the IASW 80 that runs on a CD 200 and communicates with the AE 1 either through a mutually trusted DC 40 or directly, or by using an accessory or some other trusted device capable of communicating with the AE 1 and hosting appropriate administrative software.

The AE 1 may be manufactured or configured to possess and/or express and/or exhibit only a sub-set of the potentially available, complete feature set.

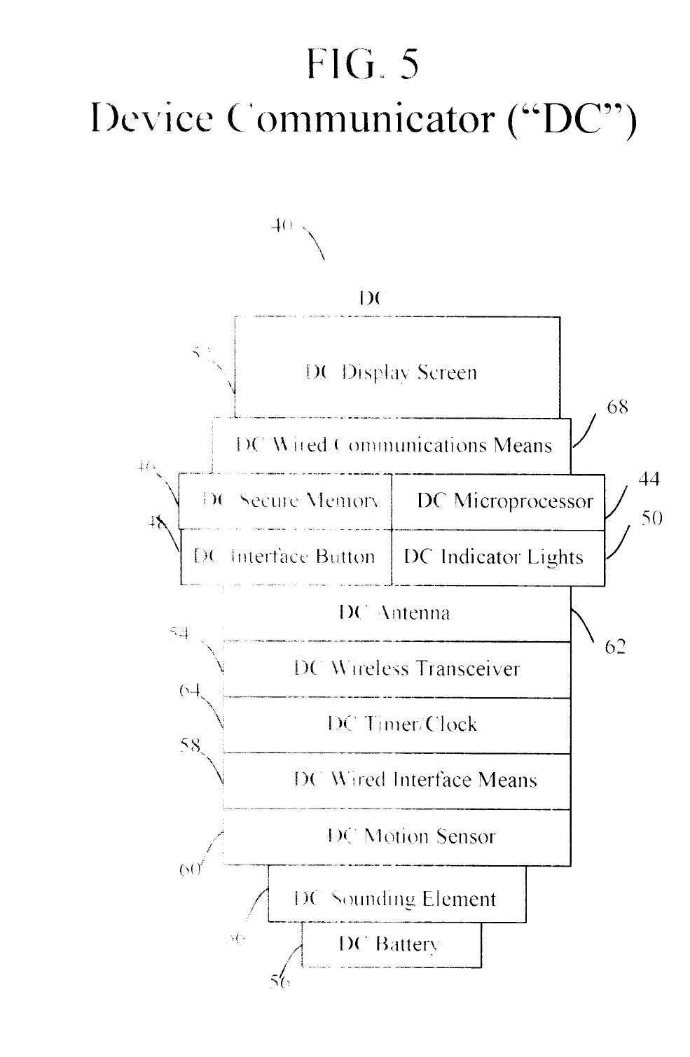

In its most highly functional form shown in FIG. 5, the DC 40 may be one component of a combined motion/proximity system for asset and data protection and one component of a bio-authentication system. It is a secure repository of a rules database, of its own configuration parameters and of its own identity credentials. A DC 40 may be bound to (trusts and is trusted by) one or more AE 1, and a DC 40 can only be activated by and only responds to an AE 1 that it trusts. The AE 1, in turn, is only activated by its registered owner/user and only via bio-authentication. In this way, the DC 40 can only be activated/controlled by and only responds to registered owner/users via bio-authentication. The AE's 1 that a DC 40 trusts may be assigned varying roles with respect to the rights they have over the DC 40. In response to a trusted AE 1, the DC 40 may provide secure wireless notification/broadcast of its own trustworthy credentials, can relay data from the IASW 80 (to which it is interfaced and which it trusts) to a trusted AE 1 and can relay data from a trusted AE 1 to a trusted IASW 80 object while simultaneously analyzing and communicating with the AE 1 and/or the CD 200 regarding the probable threat environment of the CD 200 or DO 300. All broadcasts of sensitive information by the DC 40 and all administrative and/or configuration actions that impact the DC 40 may be either directly authorized by a trusted AE 1 via bio-authentication or may have been predefined in a rules database by a trusted AE's 1 owner via a bio-authenticated process.

The input to the DC 40 is through the DC wired interface means 58, the DC antenna 62, and the DC interface button 48. To turn the DC 40 on, the user may activate the DC interface button 48. Once activated, the DC microprocessor 44 may initiate communication with the user. The DC 40 may possess certain capabilities for interfacing directly with natural persons. These capabilities may include, but are not necessarily limited to, switches, buttons, sound producing mechanisms, vibration mechanisms, indicator lights or display screens. These interface capabilities may serve input or output functions or both. In the current embodiment depicted in FIG. 5 the interface means may include the DC display screen 52, the DC sounding element 66 or the DC indicator lights 50.

The first communication to the user may request that the user biometrically authenticate himself to the AE 1 through the AE biometric sensor 2, thereby causing the AE 1 to transmit wireless data 30. Following this request by the DC microprocessor 44, the DC microprocessor 44 may then activate the DC wireless transceiver 54 and command it begin listening for incoming wireless communications through the DC antenna 62. Once the DC wireless transceiver 54 receives a wireless communication it may pass it along to the DC microprocessor 44 for processing to determine if the wireless data is the anticipated wireless data 30 from the AE 1. To determine if the wireless communication is the anticipated wireless data 30 from the AE 1, the DC microprocessor 44 reads from the DC secure memory 46 and performs a matching function to assess its validity though comparisons of incoming security identifiers within the data stream of the wireless data 30 to those stored in the DC secure memory 46.

If the wireless communication received from free space by the DC antenna 62 and processed by the DC wireless transceiver 54 and DC microprocessor 44 is determined by the DC microprocessor 44 to be the anticipated wireless data 30, it will be further processed and passed along to the IASW 80 through the DC wired interface means 58.

If the wireless communication received from free space by the DC antenna 62 and processed by the DC wireless transceiver 54 and DC microprocessor 44 is determined by the DC microprocessor 44 not to be the anticipated wireless data 30, the DC microprocessor 44 may cause the DC 40 to communicate the improper receipt of the wireless communication to the user through one or more means that may include the DC display screen 52, the DC sounding element 66 or the DC indicator lights 50. The DC microprocessor 44 may also communicate the improper receipt of the wireless communication to the IASW 80 through the DC wired interface means 58, and the IASW 80 may then communicate with the user directly, through means of its own.

If no wireless communication is received from free space by the DC antenna 62, the DC microprocessor 44 may cause the DC 40 to communicate the absence of wireless communication to the user through one or more means that may include the DC display screen 52, the DC sounding element 66 or the DC indicator lights 50. The DC microprocessor 44 may also communicate the absence of wireless communication to the IASW 80 through the DC wired interface means 58, and the IASW 80 may then communicate with the user directly, through means of its own.

The DC 40 may be configured by the user/owner of a trusted AE 1 to request wireless data 30 from the AE 1 and/or to determine the motion/proximity status of the AE 1 periodically, upon request, in accordance to the spatial proximity of the DC 40 to the AE 1, or in accordance to some other logic incorporating, but not limited to, one or more of the following: time, proximity, motion, activation command, biometric authentication match, or upon receipt of a request from a trusted AE 1 or a trusted IASW 80 object. If done in accordance to time, the DC 40 makes use of the DC timer/clock 64. If the request for wireless data 30 is based on proximity, the DC 40 uses the DC wireless transceiver 54 to measure the strength of the wireless signal received from the AE wireless transceiver 14 and uses that measurement to determine whether the AE 1 is in close proximity to the DC 40. If based on motion, the DC microprocessor 44 activates the DC motion sensor 60 to determine if the DC 40 is in physical motion. The activation of the DC motion sensor 60 by the DC microprocessor 44 may be configured such that it only occurs when the AE 1 is determined to be out of close proximity to the DC 40. If the request for wireless data 30 originals from the IASW 80, such a command would be received by the DC microprocessor 44 through the DC wired interface means 58.

Each individual DC 40 may be “bound” or “paired” with (trusts and is trusted by) at least one AE 1 and potentially multiple AEs 1 in more complex implementations where different AEs 1 may be assigned different roles with respect to a given DC 40. Binding or pairing of an AE 1 to a DC 40 may be a one time administrative event that establishes a persistent state of trust between the AE 1 and DC 40 pair.

Each individual DC 40 may bound or paired with (trusts and is trusted by) one or more IASW 80 code objects. Binding or pairing of a DC 40 to an IASW 80 object may be a one time administrative event that establishes a persistent state of trust between the DC 40 and IASW 80 object pair.

The DC 40 may be implemented in various form factors. In one set of embodiments, the DC 40 may be physically attached externally to the CD 200 or other DO 300. In another set of embodiments, the DC 40 may have a form factor that allows it to be inserted into a specific, standard slot or cavity on a CD 200 and to interface electronically with the CD 200 (for example, a PCMCIA form factor). In yet another set of embodiments, the DC 40 may be integrated (perhaps in the form of a micro-chip or other electronic circuitry) into the circuit boards of CDs 200 such as, but not limited to, computers, cellphones, PDAs or pagers. In each of the above embodiments, the DC 40 may be powered by its own battery 56 (replaceable or rechargeable), powered by the host CD 200 through the DC wired interface means 58. The DC 40 may be durable, water-resistant and/or possess other characteristics contributing to the reliability of the DC 40 under a broad set of environmental conditions. The DC 40 may be comprised of multiple pieces that are physically separable. The purpose of such physically separable pieces is to easily and perhaps temporarily add or remove functionality to/from the DC 40 in the form of accessories. One such accessory, among many other possibilities, might be a holder/holster into which a DC 40 of PCMCIA form-factor could be inserted to allow it to be more readily attached externally to a CD 200 or DO 300.

In keeping with its role as a secure data repository, the DC 40 may be capable of storing data in encrypted form and/or capable of applying rules that control data access. This may be done through the DC microprocessor 44 and the secure memory 46. When data does not need to be encrypted in the DC's 40 database, it may be stored “in the clear” within the DC microprocessor 44. In keeping with the need to broadcast data securely, the DC 40 may have the capability to encrypt data before broadcast and to decrypt data that is broadcast to it. This may be done through the DC microprocessor 44 and DC secure memory 46.

The DC 40 may be tamper-evident and tamper-resistant where these features may be implemented through physical attributes of the DC 40, through logical attributes of the DC 40 or a combination of the two. One example of a physical tamper-resistant feature would be the “potting” (e.g. casting, encasement in epoxy or another material) of the DC's 40 internal electrical components (DC microprocessor 44, DC secure memory 46, among others) in order to increase the difficulty of gaining physical access to those internal electrical components and connections. Another example of a DC 40 tamper-resistance capability might be its ability to detect that it had been ejected from the PCMCIA slot thus causing it to sound a predefined alarm through the DC sounding element 66. One example of a logical tamper-evident feature would be the hashing and digital signing of the DC's 40 known-good executable code so that the integrity of that code could be easily verified in the future before deciding to rely on the DC's 40 code for some critical operation.

The DC 40, when implemented in a form factor that is electronically interfaced to a CD 200, may be capable of monitoring the CD for certain potentially intrusive events such as removal of the hard drive, the CD 200 data drive, the battery or some other such event. In order to implement these capabilities, the DC 40 must be interfaced to a CD 200 that can detect such events and that can communicate such event occurrences to the DC 40 through the DC wired interface means 58. Once the DC 40 receives such event occurrence data, the DC 40 may refer to its predefined database of rules and may produce alarms through the DC sounding element 66, or take other actions.

In order to support faster communication and to reduce the real or perceived risks of wireless communication with an AE 1 and/or IASW 80 objects (for example during certain sensitive administrative processes), certain embodiments of the DC 40 may be provided with a DC “wired” communication means 68 such as USB, FireWire, serial, Dallas Semiconductor button, docking station or other similar means.

Information may be stored in or deleted from the DC 40, rules may be established in the DC 40 and/or configuration parameters may be set or changed in the DC 40 either by the user/owner based on bio-authentication to a trusted AE 1 or by a group administrator(s) to whom a trusted AE's 1 user/owner delegates specific rights also based on bio-authentication. The user/owner and/or an authorized administrator may accomplish administrative functions such as the above either by using the interface capabilities built into the DC 40, by using the IASW 80 that runs on a CD 200 and communicates with the DC 40, or by using an accessory or some other trusted device capable of communicating with the DC 40 and of hosting appropriate administrative software.

The DC 40 may exist as an independent system without data connectivity to the CD 200 through the IASW 80.

In the absence of the receipt of authorized credentials from a trusted AE 1, the DC 40 may take action to appropriately secure itself, or the system it is designed to protect. This may include the transmission of alerts, alarms, distress beacons, or the engagement of some other function. Upon receipt of authorized credentials, the DC may allow access to itself or the system it is designed to protect, suppressing the alerts, alarms and other functions described above.

In order to reduce the number of devices that must be connected to a given CD 200 and because the DC 40 requires robust, secure, wireless 2-way communication capabilities (both proprietary and industry-standard) to fulfill its proprietary designed functions, the DC 40 may be implemented so as to function as a generic, industry-standard wireless communication “port”.

The DC 40 may be manufactured or configured to possess and/or express and/or exhibit only a sub-set of the potentially available, complete feature set.

The CD 200, in the absence of the receipt of certain information directly from a trusted AE 1 or from a trusted AE 1 via a trusted DC 40 and trusted IASW 80, may take action to appropriately secure itself, and/or the system it is designed to protect. This may include securing the CD data 118 that resides on the CD 200 and/or performing some other function. Likewise, upon receipt of certain information (which may include the authorized user's credentials), the CD 200 may allow access to itself or the system it is designed to protect, thereby enabling a variety of other functions to be performed in accordance to the level of security associated with a particular user's credentials.

The IASW 80 provides a software interface (graphical user interface) for administration of the AE 1 and/or DC 40 and/or itself. It may allow an owner/user and/or a duly authorized administrator to make modifications to the rules and logic upon which the system operates. It may allow for the administration of multiple users, and also may allow individual users to customize their own personal functional settings. It may allow for the registration and association of individuals in the biometric authentication process, and associates individuals to varying levels of security and to specific roles. The IASW 80 may also enable the DC 40 to interface with the CD 200 and/or enable the AE 1 to communicate with the CD 40, providing user credentials along with other information. The IASW 80 may possess trustworthy identity credentials that it may use to identify itself to a DC 40 or an AE 1. The IASW 80 may be bound to (trusts and is trusted by) one or more DCs 40 and/or one or more AEs 1, and the IASW 80 may only communicate with DCs 40 and/or AEs 1 that it trusts. The IASW 80 may be capable of vouching for its own integrity via a mechanism such as, but not limited to, a digitally signed hash (for example using MD-5 or SHA-1 hashing algorithms) of its executable program code object(s). The IASW 80 may be capable of encrypting data that it sends to other trusted devices or objects and capable of decrypting encrypted data that is sent to it by devices/objects/parties that it trusts. The IASW 80 may be configurable such that different trusted devices/objects/parties play different roles and are granted different rights and privileges with respect to the IASW 80 functionality and data.

The DC 40 may enable the computing device to communicate wirelessly with the AE 1, or it may exist independent of enabling communication with the CD 200. The DC 40 may be in the form of a PCMCIA card, a USB-enabled system, internal to the CD 200 itself, external to the CD 200, or in some other form. Its functionality, along with that of the AE 1, may be set through the IASW 80 and/or by mechanical means.

The AE 1 may communicate with one or more biometric authentication systems (for example, a fingerprint recognition system), so that the user may authenticate himself before the AE 1 transmits secure information to the DC 200. Secure information may include, but is not limited to, any or all of the following: name, social security number, identification number, biometric information, medical records, security information, other personal information, company information, government security level, and/or encryption keys. The user may be prompted to authenticate himself in response to a request, periodically, or according to some other logic. Requests for authentication may originate from a number of different sources, including but not limited to, the CD 200, the DC 40, a network, the IASW 80, other resident or remote software, or other systems connected to the CD 200.

The AE 1 is capable of hosting a biometric authentication system internally, in which case the AE 1 of this invention would then comprise a remote wireless system that employs biometrics (fingerprint recognition or other means) to authenticate the user prior to communicating securely with the DC 40. The biometric means are well know to those versed in the state of the art and are commercially available from such companies as STMicroelectronics and Identix. In such an embodiment, the use user may be required to authenticate himself to the AE 1 to turn the device on, on a periodic basis thereafter, on request from the CD 200, DC 40, or on some other event that warrants an elevated level of security (for example, when making an online purchase with a credit card).

The AE 1 may sound an alert, activate a vibration means, or activate visible means indicating to the user that he must authenticate himself to the AE 1 (for example, by running his fingerprint along a special window embedded in the AE 1 that allows for the reading of a fingerprint). The AE 1 may then compare the live fingerprint scan to a data file containing information about an authorized fingerprint that is stored in the secure memory of the AE 1. The fingerprint data file may contain information about the authorized fingerprint in whole or a digitized representation thereof. If the comparison yields a positive match, the AE 1 may proceed to establish a secure communication link with the DC 40 and proceed to transmit the user's credentials or other stored information to the DC 40. Alternatively, biometric information may be directly transmitted to the DC 40 for analysis, matching and other security processes.

The AE 1, the DC 40, and the IASW 80 may communicate with the CD 200 securely and participate in an established system of trust. The software and functional characteristics of the AE 1 and DC 40 may be user customizable either through mechanical means or through the IASW 80. In addition to transmitting information to the device, the AE 1 may also receive and store information from the DC 40 for future retrieval and processing.

In the case of a wireless means for communication, when the user is within a user-defined proximity radius (i.e., range) of the DC 40, the AE 1 may be configured to begin communication with the DC 40. The transmission of the user's credentials, or other more or less benign information, may be set to begin automatically when a pre-specified proximity is reached between the AE 1 and the DC 40, or the transmission may be set to occur periodically in time, in response to motion of the AE 1 as measured by the AE motion sensor 20, in response to motion of the CD 200, in response to motion of the DC 40, in response to attempted access of the CD 200, or in accordance with some other logic. In the absence of receipt of the proper credentials from the AE 1, the Bio-authentication System A 100, Bio-authentication System B 400 and Bio-authentication System C 500, may be configured to take a multitude of actions, for example, to protect the asset, to protect the system associated with the CD 200, or to secure the data that resides thereon.

The AE 1 and DC 40 may be configured to enable asset protection. In such an embodiment, the user is provided with means for protecting the CD 200 from theft or unintentional abandonment. In one embodiment, a motion detection means commonly known to those versed in the state of the art and commercially available by such companies as STMicroelectronics, is attached to the CD 200, contained within the CD 200, or is part of the DC 40 as already discussed.

In this embodiment, an instruction set is invoked which determines the level of security threat based on the motion of the device, proximity of the AE 1 to the DC 40, receipt of the user's credentials, time of day, day or week, or risk level assigned to the device, among other parameters. Depending on the level of security threat, several actions may be taken.

For a high-level security threat, the user may be notified by sound and/or vibration and/or visible means on the AE 1 and/or the CD 200 or DC 40. In addition, the CD 200 or DC 40 may transmit a distress alert or beacon that may be picked up by other wireless means, which may be connected remotely to various authorized users, security personnel, or other locations.

For a low level of security threat, the CD 200 or DC 40 may simply sound an audible alert/alarm in accordance to the persistence of motion. The range of actions taken when various security threats are determined is intended to encompass a wide range of options, only some of which are specified above.

Similarly, the AE 1 and DC 40 may also be configured to communicate with CD 200 data security systems or enable data security via the DC 40 and the IASW 80. The user is effectively provided a means for securing the data stored on the CD 200 from unauthorized access. In one embodiment, an instruction set is invoked to determine the level of security threat based on the motion of the device, keyboard activity, bus activity, network activity, proximity of the AE 1 to the DC 40, receipt of the user's credentials, time of day, day or week, or risk level assigned to the device, among other parameters. Depending on the level of security threat, one or more of several actions may be taken. For example, access of the data may be restricted by launching a gateway; select data may be erased; select data may be encrypted; the user may be notified audibly, visibly, and/or by vibration on the AE 1, the CD 200, or DC 40; the CD 200 may transmit a distress alert that may be picked up by other wireless means, which may be connected remotely to various authorized users, security personnel, or other locations; or other actions, to name a few. The range of actions taken when various security threats are determined is intended to encompass a wide range of options, only some of which are specified above.

The AE 1, as described above in its various forms, may be embodied within some other system. Examples include, but are not limited to, PDAs, cell phones, pagers and portable GPS systems. A fully integrated AE 1 built into a cell phone or PDA may allow the user to employ a device that he would regularly carry on his person as a platform to host the AE 1. Alternatively, the AE 1 could also incorporate technologies enabling other systems such as cell phones, GPS and palm-based computing, to name a few. It is the objective of the invention to ultimately integrate the AE 1 into standard portable electronic devices.

### Equivalents

While the invention has been particularly shown and described with reference to specific embodiments, it should be understood by those skilled in the art that various changes in form and detail may be made therein without departing from the spirit and scope of the invention as defined herein

1. a security system comprising:
a) an authentication element that receives a biometric characteristic from a user, the authentication element broadcasting an authorization signal in response to identifying the user; and
b) a device communicator in wireless communication with the authentication element and in electrical communication with a computing device, the device communicator permitting the user to access the computing device in response to receiving the authorization signal broadcasted by the authentication element.

2. The security system of claim 1 further comprising a sensor that is attached to at least one of the authentication element and the device communicator, the sensor generating a sensor signal that is related to a status of at least one of the authentication element, the device communicator, and the computing device.

3. The security system of claim 2 wherein the sensor comprises a motion sensor and the status of the at least one of the authentication element, the device communicator, and the computing device is related to a motion of the device communicator.

4. The security system of claim 2 wherein the sensor comprises a proximity sensor and the status of the at least one of the authentication element, the device communicator, and the computing device is related to a distance between the authentication element and the computing device.

5. The security system of claim 2 wherein the sensor comprises a motion/proximity sensor and the status of the at least one of the authentication element, the device communicator, and the computing device is related to a motion of the device communicator and a distance between the authentication element and the computing device.

6. The security system of claim 2 wherein the sensor comprises a clock and the status of the at least one of the authentication element, the device communicator, and the computing device is related to a time interval between two predetermined events associated with at least one of the authentication element, the device communicator, and the computing device.

7. The security system of claim 1 wherein the biometric characteristic is chosen from the group comprising a finger-print, a retinal scan, a voice-print, a DNA signature, a facial scan, body impedance, and a written signature.

8. The security system of claim 1 wherein the authentication element comprises an electronic circuit that is integrated into at least one of a computer, a cellular telephone, a personal digital assistant, and a pager.

9. The security system of claim 1 wherein the authentication element is bound to at least one of the device communicator and the computing device.

10. The security system of claim 1 wherein at least one of the authentication element, the device communicator, and the computing device further comprises an alarm that indicates a presence of an unauthorized user.

11. The security system of claim 10 wherein the alarm is chosen from the group comprising an audible alarm, a light, a distress beacon, a vibrator, and an electric shock device.

12. A security system comprising:
a) an authentication element that receives a biometric characteristic from a user, the authentication element broadcasting an authorization signal in response to identifying the user; and
b) a computing device in wireless communication with the authentication element, the computing device executing a software program in response to receiving the authorization signal broadcasted by the authentication element the software program permitting the user to access the computing device.

13. The security system of claim 12 wherein the software program comprises an interface/administration software program.

14. The security system of claim 12 wherein the authentication element is bound to the computing device.

15. The security system of claim 12 further comprising a sensor that is attached to the authentication element, the sensor generating a sensor signal that is related to a status of at least one of the authentication element and the computing device.

16. The security system of claim 12 wherein the biometric characteristic is chosen from the group comprising a finger-print, a retinal scan, a voice-print, a DNA signature, a facial scan, body impedance, and a written signature.

17. A method of authenticating a user to a computing device, the method comprising:
a) obtaining a biometric characteristic from a user that identifies the user;
b) broadcasting an authorization signal that is related to the biometric characteristic;
c) receiving the authorization signal that is related to the biometric characteristic; and
d) permitting the user to access the computing device in response to receiving the authorization signal.

18. The method of claim 17 wherein the permitting the user to access the computing device provides the user physical access to a secured area.

19. The method of claim 17 wherein the permitting the user to access the computing device provides the user access to a computer network.

20. The method of claim 17 wherein the permitting the user to access the computing device provides the user access to secured data.

21. The method of claim 17 wherein the biometric characteristic is chosen from the group comprising a finger-print, a retinal scan, a voice-print, a DNA signature, a facial scan, body impedance, and a written signature.

22. The method of claim 17 wherein the authorization signal is transmitted through at least one of a wireless communication system, a IR communication system, an optical communication system and an acoustical communication system.

23. The method of claim 17 further comprising sensing a status of the computing device in response to the presence of the authorization signal.

24. The method of claim 23 wherein the status of the computing device is chosen from the group comprising a proximity of the user to the computing device, a motion of the computing device relative to the user, a receipt of a user credential, and a risk level assigned to the computing device.

25. The method of claim 17 further comprising sensing a status of the computing device in response to the absence of the authorization signal.

26. The method of claim 25 wherein the status of the computing device is chosen from the group comprising a proximity of the user to the computing device, a motion of the computing device relative to the user, a receipt of a user credential, and a risk level assigned to the computing device.

27. The method of claim 17 further comprising denying the user access to the computing device in response to an absence of the authorization signal.

28. The method of claim 17 further comprising securing the computing device in response to an absence of the authorization signal.

29. A security system comprising:
a) means for obtaining a biometric characteristic from a user that identifies the user;
b) means for broadcasting an authorization signal that is related to the biometric characteristic;
c) means for receiving the authorization signal that is related to the biometric characteristic; and
d) means for permitting the user to access the computing device in response to receiving the authorization signal.
